(19) United States
(12) Patent Application Publication
(10) Pub. No.: US 2020/0359467 A1
(43) Pub. Date: Nov. 12, 2020

(54) COATING DELETION FOR ELECTRICAL CONNECTION ON VEHICLE WINDOW

(71) Applicant: CENTRAL GLASS COMPANY, LIMITED, Ube-shi, Yamaguchi (JP)

(72) Inventors: Olivier FARREYROL, Machtum (LU); Katharina BOGUSLAWSKI, Trier (DE)

(73) Assignee: CENTRAL GLASS COMPANY, LIMITED, Ube-shi, Yamaguchi (JP)

(21) Appl. No.: 16/961,426

(22) PCT Filed: Jan. 15, 2019
(86) PCT No.: PCT/US2019/013610

§ 371 Date: Jul. 10, 2020

Related U.S. Application Data
(60) Provisional application No. 62/617,764, filed on Jan. 16, 2018.

(51) Int. Cl. H05B 3/84; B32B 17/10; C03C 17/36; C03C 27/06; B23K 26/364; H05B 3/14; H05B 3/06; H05B 3/16; H05B 3/18

(52) U.S. Cl. CPC H05B 3/84; H05B 3/86; B32B 17/10385; B32B 17/10229; B32B 17/10816; B32B 17/10761; C03C 17/3639; C03C 17/3681; C03C 27/06; B23K 26/364; H05B 3/141; H05B 3/06; H05B 3/16; H05B 3/18; H05B 3/146; B32B 2605/00; C03C 2218/33; B32B 17/10036

(57) ABSTRACT

The present disclosure relates to a vehicle glazing, comprising: a first glass substrate having surfaces S1 and S2 wherein S1 faces a vehicle exterior; a second glass substrate having surfaces S3 and S4 wherein S4 faces a vehicle interior; at least one polymer interlayer between the first glass substrate and the second glass substrate; and a coating on at least one surface of at least one of the first and second glass substrates, wherein at least one opening is formed in the coating, and the opening is filled with an electrically conductive material, wherein the electrically conductive material is attached to at least one electrical connector.

### CROSS REFERENCE TO RELATED APPLICATION

This application claims priority to U.S. Provisional Patent Application No. 62/617,764 filed on Jan. 16, 2018, entitled “WAVY LASER DELETION FOR BUSBAR CREATION ON HEATABLE VEHICLE WINDOW,” the content of which is incorporated by reference herein in its entirety.

### TECHNICAL FIELDS

The present disclosure generally relates to an electrically conductive laminated vehicle glazing (e.g., vehicle windshield). More specifically, this disclosure relates to a busbar creation by coating deletion technology to provide one or more electrical connections to a conductive coating on/in laminated vehicle windows.

### BACKGROUND

Conductive coatings on a vehicle window may have various uses, including heating the window. Heatable laminated vehicle windows may be configured to melt snow, ice or frost, which may be especially useful during winter seasons or in cold areas. Such a heatable function may be provided by an infrared reflective (IRR) coating on the laminated vehicle windows which also significantly reduces infrared solar radiation into a vehicle and improves comfort in the vehicle.

Heatable IRR coating technology for automotive glazing may provide a coating comprising at least one layer of metallic silver, typically two or three metallic silver layers deposited by physical vapor deposition (PVD) (e.g., vacuum sputtering) or chemical vapor deposition (CVD) technologies. It also comprises several other thin layers for matching desired refractive indices, promoting adhesion, compensating for thermal expansion and/or reducing corrosion or scratches during production (e.g., during a bending process) or actual usage. Each thin film layer in the heatable IRR coating has a thickness of a few tens nanometers such that the heatable IRR coating is transparent or semi-transparent.

While the metallic silver layers in the heatable IRR coating are electrically conductive, most of the other layers, including a top layer, are dielectric or insulators, hence electrically non-conductive (e.g., metal oxides, metal nitride or metal oxynitride). As shown in FIG. 1, a conventional structure may include an outer glass pane 110, a polymer layer 118, a heatable IRR coating 116 and an inner glass pane 120. The heatable IRR coating 116 may be on a surface S3 122 of an automotive laminated glazing (e.g., windshield) where a surface S1 112 faces a vehicle exterior, a surface S2 114 is on an opposite side of the S1 surface 112, S2 114 and S3 122 surfaces are inside the laminated glazing, and a surface S4 124 is an external side of the glazing facing the inside of the vehicle.

The heatable IRR coating 116 may be deposited onto a large flat glass substrate/pane 120 (e.g., soda-lime glass substrate/pane manufactured by a float method known in the art). The flat, coated glass substrate 120 may then be bent in a thermal bending process temperature region (e.g., greater than 630° C. for soda-lime glass) to obtain a required two or three-dimensional shape to be fit for a vehicle's window. It is desirable for the coating 116 to survive before and after heat treatment (e.g., during a thermal tempering or bending process), i.e., to be mechanically and/or chemically durable. For example, it may be desirable that the coating 116 does not oxidize, have visible light transmittance less than 70%, or show defects.

There are several examples of making automotive windows with IRR coatings. For example, U.S. Pat. No. 6,686,050 B2 generally discloses an example automotive window having an IRR coating comprising two metallic silver layers. U.S. Pat. No. 9,482,799 B2 generally discloses an example IRR coating comprising three metallic silver layers.

As described herein, and as shown in FIG. 3, the metallic silver layers 338 in the heatable IRR coating 116 are electrically conductive. The silver layers 338 may be a surface resistor, having a sheet resistance property, which may be connected to an external power source (e.g., a battery of a vehicle). The electrically conductive silver layers 338 provide an electrical heating function that may defrost or defog an automotive laminated window. The electrically conductive silver layers 338 may be sandwiched by non-electrically conductive dielectric (sub) layers 336; however, the silver layers 338 require electrical contact to provide the heating function. Typically, electrical contact may be formed via a busbar arrangement from/to the external power source. A busbar 232 may be a strip of conductive material screen printed onto an exposed surface of a conductively coated glass. The primary function of a busbar is to conduct electricity.

There are several examples of arranging busbars for automotive windows. For example, U.S. Pat. No. 6,492,619 B1 generally discloses a busbar arrangement for a heatable automotive window having a heatable IRR coating essentially consisting of two silver layers.

For example, silver paste enamel material 232 may be printed by a silk-screen printing process onto a heatable IRR coating deposited on a flat glass substrate before heat-treatment, i.e., thermal bending process. During the bending process, which concurrently fires the silver paste busbar 232 at a temperature range of 600 to 700° C., silver particles 334 in the enamel print 232 may migrate 340 from the top surface of the heatable IRR coating through the non-electrically conductive dielectric (sub)layers 336 and eventually reach the electrically conductive silver layers 338 (see FIG. 3). Finally, electric voltage is provided via the silver busbars 232 from the external power source (e.g., a DC battery in a vehicle) to the silver layers 338 in the heatable IRR coating in an automotive laminated window.

In sum, a conventional manufacturing process of a heatable laminated vehicle window known in the art may comprise the following steps, which are illustrated in FIGS. 2-3.

Step 1 comprises preparation of a flat outer glass pane 210 with S1 212 and S2 214 surfaces (e.g., cut and grinding), screen printing of opaque paste enamel 234 (e.g., black enamel printing) on the S2 214 surface, and firing the opaque enamel 234.

Step 2 comprises preparation of a flat inner glass pane 220 with surfaces S3 222 and S4 224 wherein a heatable IRR coating 116 is deposited on the S3 222 surface with optional screen printing of silver paste enamel 232 for busbar arrangement on the S3 222 surface. The silver paste enamel 232 is dried and pre-fired.

Step 3 comprises assembling the outer glass pane 210 and inner glass pane 220 such that the S1 212 surface of the outer glass pane 210 is mostly downward (i.e., the surface S2 214 is upward) and the S3 222 surface of the inner glass pane 220 is on and facing the S2 214 surface (i.e., the surface S4 224 is mostly upward), as shown in FIG. 2.

Step 4 comprises simultaneously bending the pair of glass panes 210, 220 of step 3 (e.g., double glass bending). For example, a known gravity-sag bending process may be applicable. The silver busbar 232 of step 2 does not touch any transportation conveyor 240 at any time during step 4 (as shown in FIG. 2), and such silver busbar 232 is further fired during the thermal bending process. As described earlier, the silver particles 334 in the busbar 232 migrate and penetrate the heatable IRR coating 116 through non-electrically conductive sub-layers 336 and create electrical connection between the electrically conductive silver layers 338 in the coating and external power source (as shown in FIG. 3). The migration and penetration of the silver particles may occur during any firing process.

Step 5 comprises arranging an electrical connector onto the silver busbar 232 on the S3 222 surface or onto a foil tape conductively adhered to the silver busbar 232, arranging a polymer interlayer 218 (e.g., polyvinyl butyral, PVB, sheet of about 0.8 mm thickness), and a conventional lamination process (e.g., autoclaving).

### SUMMARY OF THE DISCLOSURE

Disclosed herein is a method for producing a conductive automotive window that comprises a first glass substrate having surfaces S1 and S2 wherein S1 faces a vehicle exterior and a second glass substrate having surfaces S3 and S4 wherein S4 faces a vehicle interior. The method comprises providing a coating on at least one surface of at least one of the first and second glass substrates, creating at least one deletion in the coating to form at least one opening, filling the opening with an electrically conductive material, curing the electrically conductive material, and applying at least one electrical connector to the electrically conductive material.

In certain embodiments, the opening filled with the electrically conductive material comprises at least one busbar. Further, the coating may be heatable. In certain embodiments, the coating may be an infrared reflective coating, a nanowire coating, a low-emissivity coating, or a transparent conductive oxide. In some embodiments, the coating may be an infrared reflective coating. In particular embodiments, the coating may have at least two silver layers or at least three silver layers.

In particular embodiments, the opening comprises a wave structure having a sinusoidal wave form, a triangle wave form, or a quadrangular wave form. In some embodiments, the opening may be linear or comprise a vertical pillar. The opening may be formed by a laser etching, which may include interfering laser beams. In some embodiments, the opening may be formed by physical abrasion or chemical etching.

In certain embodiments, the coating may be on a glass substrate or a polymer film.

Further, disclosed herein is a vehicle glazing comprising a first glass substrate having surfaces S1 and S2 wherein S1 faces a vehicle exterior, a second glass substrate having surfaces S3 and S4 wherein S4 faces a vehicle interior, at least one polymer interlayer between the first glass substrate and the second glass substrate, and a coating on at least one surface of at least one of the first and second glass substrates. The coating has at least one opening formed therein, wherein the opening is filled with an electrically conductive material which is attached to at least one electrical connector.

In some embodiments, the coating is provided on the S2 surface of the first glass substrate or the S3 surface of the second glass substrate.

In certain embodiments, the coating is heatable. The coating may be selected from an infrared reflective coating, a nanowire coating, a low-emissivity coating, or a transparent conductive oxide. Particularly, the coating may be an infrared reflective coating, which may include at least two silver layers or at least three silver layers.

Further embodiments may include an opening in a wave structure, which may be a sinusoidal wave form, a triangle wave form, or a quadrangular wave form. The opening may further be linear or a vertical pillar.

The opening may be formed by laser etching, physical abrasion, or chemical etching.

In certain embodiments the opening filled with an electrically conductive material comprises a busbar.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a conventional construction of a laminated glass using a heatable IRR coating technology in automotive applications;

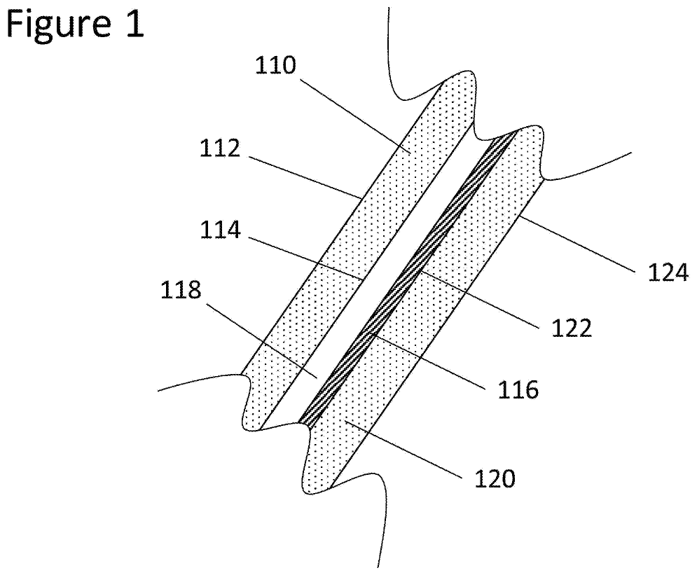

FIG. 2 illustrates a conventional arrangement of an inner and outer glass panes during (double) bending process;

FIG. 3 illustrates a conventional busbar arrangement for a heatable IRR coating;

FIG. 4 illustrates an example single glass bending process (technical problem to be solved);

FIG. 5 illustrates a laser etching process performed on a coating on bent glass in a wavy form, according to an exemplary aspect of the present disclosure;

FIG. 6 illustrates another laser etching pattern, according to an exemplary aspect of the present disclosure;

FIG. 7 illustrates a variable laser etching pattern depending upon other factors, according to an exemplary aspect of the present disclosure;

FIG. 8 illustrates an example glazing having linear etching patterns and a foil connector applied thereto;

FIG. 9 illustrates an example manufacturing process of a conductive laminated vehicle windshield, according to an exemplary aspect of the present disclosure;

FIG. 10 illustrates another example manufacturing process of a conductive laminated vehicle windshield, according to an exemplary aspect of the present disclosure; and

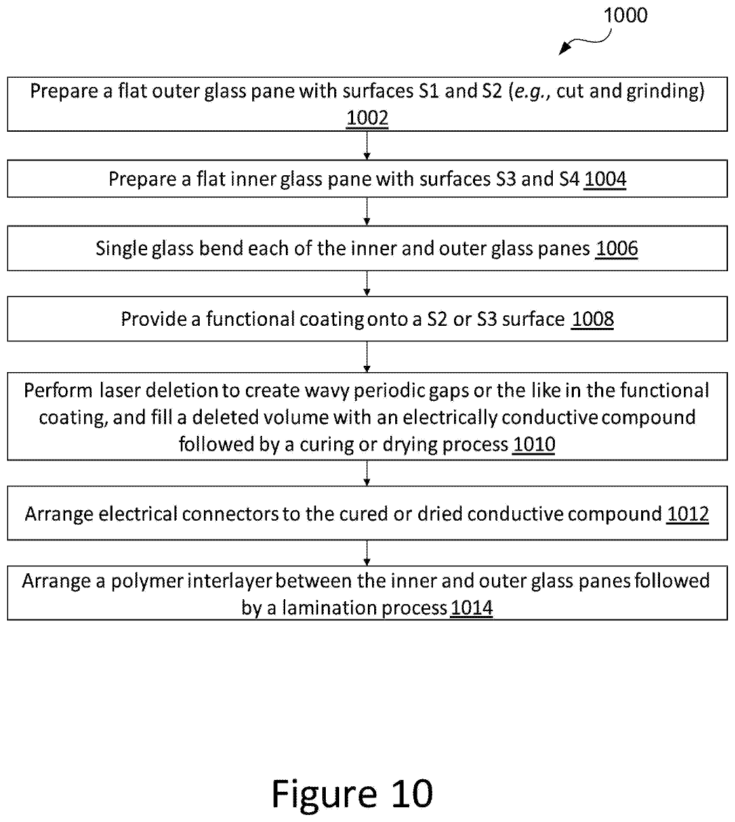

FIG. 11 illustrates yet another example manufacturing process of a conductive laminated vehicle windshield, according to an exemplary aspect of the present disclosure.

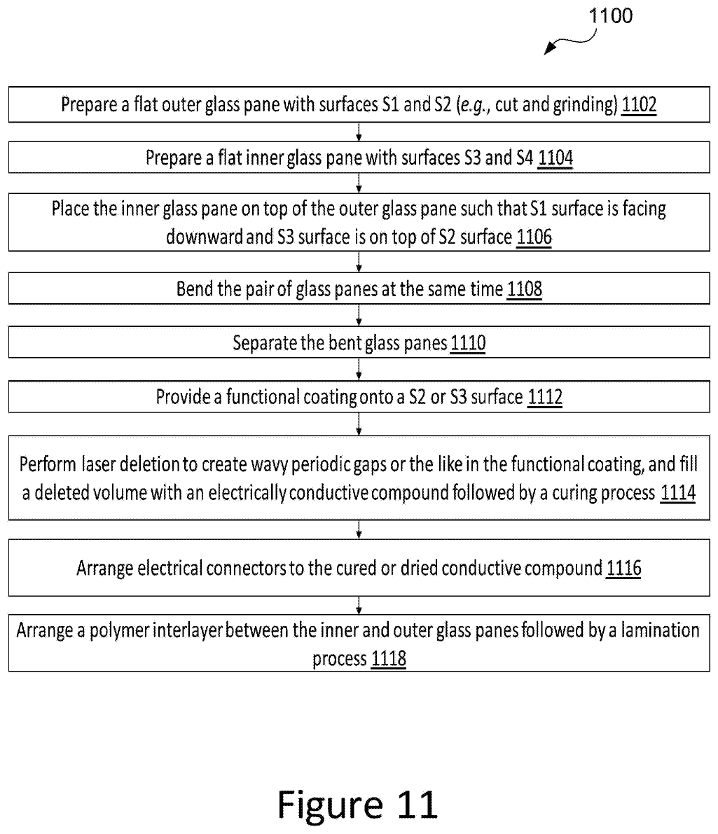

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below. This disclosure relates to solutions for any conductive coating, including those having one or more conductive layers in a coating stack or other formulations of conductive material. The descriptions herein may refer to a particular embodiment, however, the application may not be limited to a particular conductive coating material.

There is a need to bend a glass pane precisely in various applications, including the creation of a large projection area for head-up display (HUD) or in manufacturing more complicated shapes to improve design capability, such as a large panoramic windshield. Gravity sag bending, where inner and outer glass panes are stacked through the bending process, may not be able to provide such precise bending shapes. More precise bending processes, which may include a press for attaining a desired shape, may require the glass substrates to be bent individually, rather than in a stacked pair.

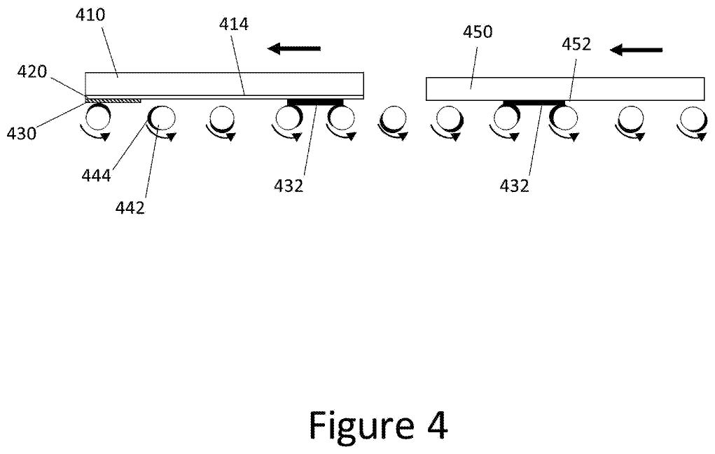

As shown in FIG. 4, a single glass bending process may process an outer glass 450 with a S1 452 surface downward and an inner glass 410 with a S3 414 surface downward, respectively. The S1 452 and S3 414 surfaces may face downward to provide correct orientation for bending the glass substrates 410, 450. Furthermore, each single glass pane 410, 450 is driven by ceramic conveyer rollers 442 into a thermal press-bending furnace. However, it is problematic to have silver busbars 430 created by screen printing on a heatable coating 420 on the S3 414 surface because the silver materials 444 may transfer to the conveyer rollers 442 causing pollution 432 of surface S1 452 and/or surface S3 414 of subsequent glass panes. Further, the silver busbars 444 may be damaged if exposed during the bending process, including the creation of scratches and other deformities, which may affect the formation of homogeneous electrical connections. During the bending process, the glass substrates are heated to a glass substrate softening point such that the glass substrates bend in a two or three-dimensional shape. A silver busbar may create an uneven heating profile on the glass substrate and undesirable residual stress around the silver busbar as heat may be more concentrated in the area of the silver busbar. The resulting glass substrate may have reduced strength in the area of the silver busbar which was heated differently than the rest of the glass substrate, which did not have a silver busbar. Further, the heat treatment of the silver busbar may form a strong bond to the glass substrate, such that any fractures in the silver busbar which may expand to the glass substrate and result in breakage of the glass substrate. The silver busbar may be a weaker surface than the glass substrate which may more easily fracture in such a way. It may be preferable to adhere the busbar to the glass substrate without heating or with heating in lower temperatures than the glass softening point wherein any fracturing may not extend through the glass substrate. Among other things, an object of the present disclosure is to solve the aforementioned problems.

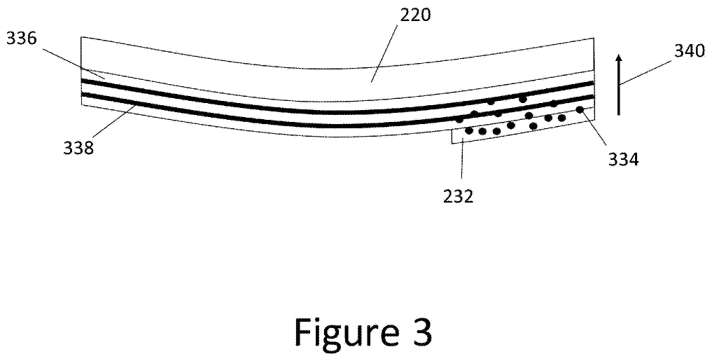

Further, silver particle migration and penetration 340 during firing (in the bending process), as shown in FIG. 3, may be insufficient to provide a desired electrical conduction. In the firing process, silver particles 334 in a silver busbar 232 migrate 340 through an underlying coating stack 116 having silver 338 and non-conductive 336 layers during a heating treatment. FIG. 3 illustrates the migration 340 on a second glass substrate 220. In the case of a heatable IRR coating comprising three or more silver layers, silver particle migration may not reach each silver layer since a total layer thickness of the IRR coating comprising three silver layers is comparatively thicker than the thickness of an IRR coating comprising two silver layers. For example, the total thickness of an IRR coating comprising three silver layers may be in the range of about 300 to 500 nm while that of an IRR coating comprising two silver layers may be in the range of about 150 to 250 nm. Even where a coating includes one or two conductive layers, the silver particles may not migrate to the conductive layers if not fired correctly. Further, top coating materials and intermediate non-conductive layers may not readily allow the transfer of silver particles, even where there are one or two silver layers. Coating development may be hindered by such a restriction. A strong top coat or non-passable materials through which silver particles may not migrate may be desired in a conductive coating. Further conductive coatings, including low-E, transparent conductive oxides, and conductive nanowire coatings, such as silver nanowires (AgNW), may also have a top coat or other non-conductive materials. Nanowires, for example, may be individually coated with material that may not be durable and/or passive to silver particles. The conductive coating, in any form, may further be heatable. Thus, another object of the present disclosure is to provide an efficient bus bar creation and arrangement for a conductive laminated glazing with a conductive coating.

Yet another object of the present disclosure is to provide a process for cost efficient busbar creation and arrangement with improved productivity.

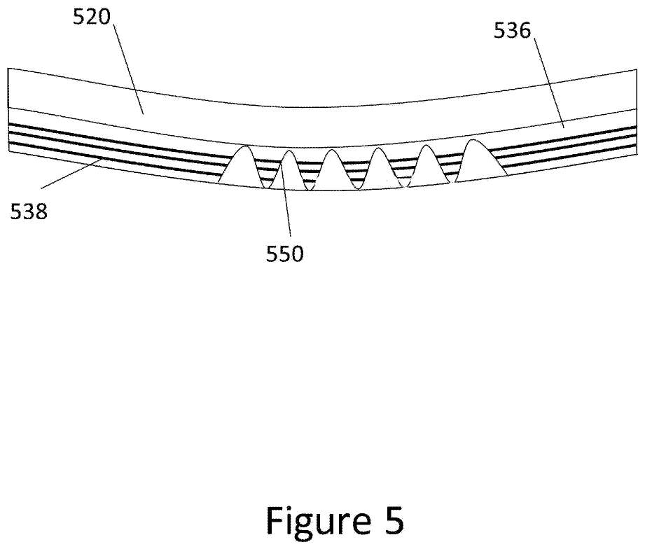

Disclosed herein, among other features, is a process of forming at least one opening in a coating. The openings may be formed before or after a thermal bending process. The opening may be formed by any suitable means, including, but not limited to physical abrasion, chemical etching, or laser etching. The openings described herein may extend through all or part of the coating, as shown in FIGS. 5-7. The coating may include conductive and non-conductive material in any form, including stacked and non-stacked materials. Preferably, the opening reaches each conductive layer 538, 638, 738 or part of the coating. The opening(s) may be formed such that each of the coating's conductive layers 538, 638, 738 or parts are exposed through the opening(s). For example, in the case of a layered silver stack, base layers of the stack may be applied to a glass substrate 520, 620, 720 before a silver layer 538, 638, 738. The opening 550, 650, 750 may not extend through non-conductive base layers adjacent to the glass and may still be deep enough to reach each conductive layer 538, 638, 738. Regarding FIGS. 5-7, the deletion 550, 650, 750 of a stacked coating 536, 636, 736 extends through each conductive layer 538, 638, 738 of the coating 536, 636, 736 but does not reach the surface of the coated glass substrate 520, 620, 720.

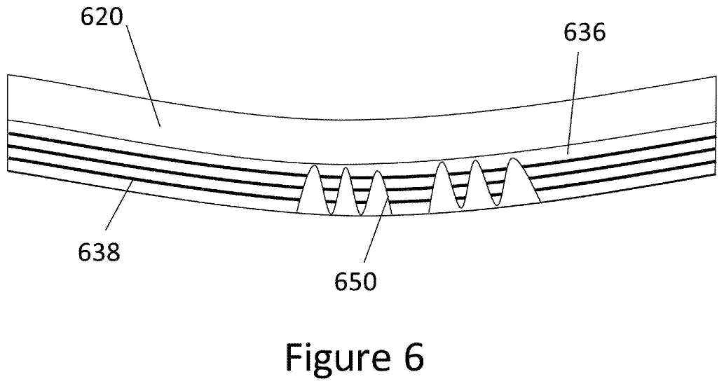

The opening(s) may be any shape to expose conductive layers or elements of a coating, including wave, linear, or pillar forms. A wave shaped opening 550, 650 may include hills and valleys along a busbar shape, as shown in FIGS. 5 and 6. The opening 550, 650 hills may reach the top of the coating stack. The opening 550, 650 interior structure in a layered coating stack may look like a layered vertical surface, similar to a cliff exposing the geological stratum layers made of the different minerals accumulated over time. In FIG. 5, an IRR coating 536 comprising three silver layers 538 is illustrated as an example without limitation. It should be appreciated that other conductive coating designs, stacked and non-stacked, may be contemplated according to aspects of the present disclosure, including IRR coatings having more, less than, or equal to three silver layers, nanowire coatings, and low-emissivity coatings. In some embodiments, conductive coatings may include coatings, such as transparent conductive oxides (e.g., indium tin oxide) having a non-conductive top coating for, for example, better handling capabilities.

As shown in FIG. 5, a deletion 550 may provide open connections to conductive materials 538, which may include metal layers 538 of a coating stack. Any other shape (e.g., periodical mountain-valley structures) may further provide access to conductive materials 538, 638. As shown in FIG. 6, the frequency-type shape of a periodic structure 650 may not be necessarily singular, and multi-superposition frequencies may be used. In addition to a sinusoidal wave structure, other similar structures such as a triangle wave or quadrangular wave may be used. A wave structure may be periodic or non-periodic. A wave pattern deletion may not be formed by a continuous deletion. For example, a series of separate deletions may be made to form a wave pattern. This may include the creation of individual openings formed in line with each other to appear as a wave. The individual openings may further include a crater shaped form having a hill within the opening such that the wave pattern may have varying hill heights. For example, the hill heights may fall at and below the coating surface height.

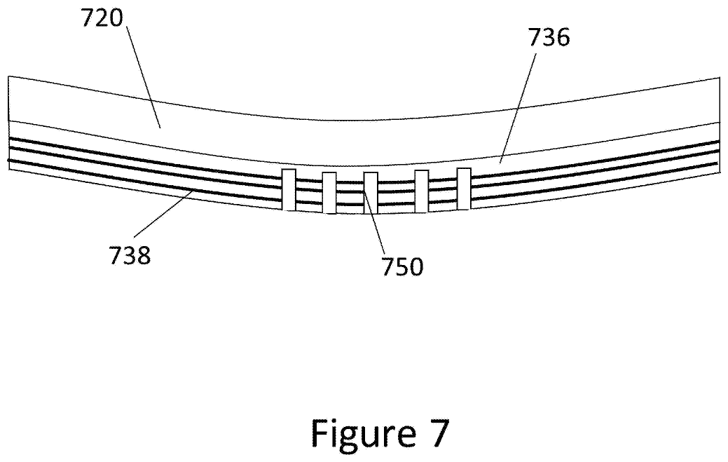

The deletions may further be formed as vertical pillars 750 to expose conductive materials 738. As shown in FIG. 7, an electrical connection may be formed by at least one vertical pillar 750 deleted from a coating 736 having conductive materials 738. Pillar shaped openings may be formed in any suitable pattern. The pattern may be periodic or non-periodic. Preferably, the pattern is formed in an area for busbar connection. More preferably, the pattern is formed across the entire busbar area.

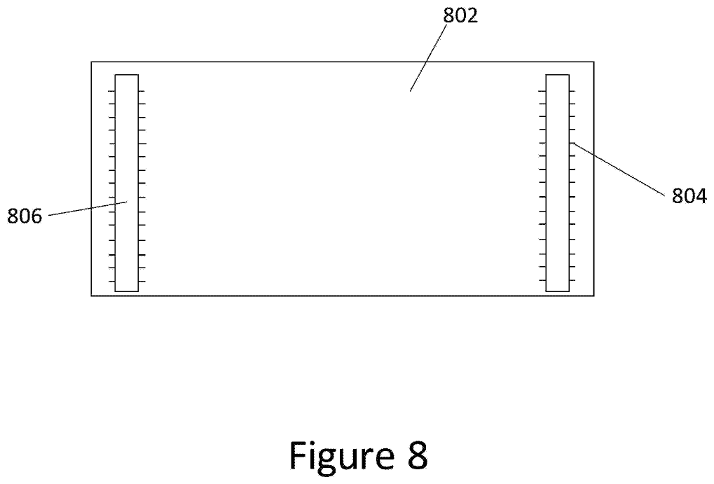

Further, non-wave or pillar structures may be used to expose lower conductive layers or materials of a coating, including linear openings 804, as shown in FIG. 8. A linear shaped opening may include a linear opening 804 formed through the coating, which may include, but is not limited to, a straight, or substantially straight line. In some embodiments, a linear shaped opening may include at least one curve or turn. The linear shaped opening may be any shape to increase contact to underlying conductive layers. FIG. 8 illustrates a coated glazing 802 having linear openings 804 formed therein. Preferably, the linear openings may be less than or equal to 15 mm, and more preferably, less than or equal to 12 mm. Preferably the linear openings 804 within a busbar area are spaced equal to or less than 5 mm apart; more preferably, less than or equal to 3 mm apart; and more preferably, less than or equal to 1.5 mm apart. The linear openings 804 may be directional, as they are longer in one direction. The linear openings are preferably parallel to an electrical current in the conductive coating and perpendicular to a connector 806 which may be applied thereto. Where the linear openings are formed perpendicular to the current, it is possible to cut off the connection, preventing any electrical connection. A lower resistance may be possible where the deleted openings are parallel to the electric current.

The frequency of openings may affect the electrical connection that may be formed. The openings provide access to conductive material to create the electrical connection. Thus, providing more access to the conductive material may provide an improved connection at the busbar, decreasing contact resistance and increasing homogeneity of the electrical connection. The openings may or may not be in a regular pattern of occurrence.

Laser power sources known in the art for laser deletion for an automotive glazing for electric sensor installation may be used. For example, equipment producing a pulsed green laser with a wavelength of 532 nm and frequency of 10 kHz may be used. Moreover, power, pulsation and/or frequency may be periodically or non-periodically varied or scanned. Variation of laser focus during scanning with or without a Galvano scanner may be also used. For another example, laser processing technology with spatial phase modulator or holographic optics may be used. Preferably, the laser processing may include interfering laser beams to create the deletion. Interfering lasers may provide a stable, energy efficient system over a focused laser beam. An axicon lens may be used to create the deleted openings described herein with interfering laser beams. Further, the interfering beams may be focused on the coating such that openings may be reliably formed on a three-dimensionally bent glass substrate.

The opening(s) may further be formed by physical abrasion of any suitable form, including scratching of the surface. Chemical etching may further be used to form the openings. Chemical etching may include the use of a mask to isolate the location of the opening(s). Chemical etching may further include the use of an oil pen to draw the etched pattern onto a coating. Further, a coating may be opened using a combination of any deletion methods.

The deleted openings may be formed before or after the glass substrate is heat treated (including the bending process). Thus, the coating may be applied before or after bending. In some cases, a coating may not be suitable to a bending process which requires high temperatures (e.g., 600-700° C.) and the coating and deletion may be done after bending a glass substrate. The disclosure herein may be used in any conductive coating, independent of a heat treatment.

Once the deleted openings are formed, a connection may be made to the exposed conductive material. Filling the deleted openings with a conductive material, which may be further cured or dried, may allow the electrically conductive layers in the conductive coating to better contact the coating surface and provide an improved busbar connection. Electrically conductive liquids, pastes or filler may be used. Preferably, the conductive liquid, paste, or filler may include silver, copper, gold, tin or other electrically conductive particles. More preferably, a liquid or paste comprising silver or tin particles may be suitable to fill the openings. Where the liquid, paste, or filler includes conductive particles, it is preferable that the deleted openings are large enough to fit such conductive particles. The viscosity of the filling material may also be any suitable viscosity to fill the deleted openings formed in the conductive coating. Preferably, the openings are completely filled such that as much conductive material in the coating is contacted by the filling material. Filling the openings may be done by any suitable process, including cold plasma and slit coating. The electrically conductive filling material may be filled at least flush to a surface level of the conductive coating. The electrically conductive filling material may overfill the opening to a level above the coating surface. Where multiple openings are formed, the electrically conductive filling material may overfill the openings and may connect the openings at the coating surface. Preferably the conductive filling creates an even surface in height and width. An even conductive filling surface may form a more homogeneous electrical connection, which may then be formed at the conductive material at the coating surface. The electrical connection can be made with any suitable connector, such as a metal plate or foil and attached by any suitable means, including soldering or with conductive adhesive. Preferably, the foil may be a copper foil. When power is applied to the coating, it may then heat, or otherwise provide power to, the laminated glazing due to the electrical connection formed at the deleted coating.

In a particular example, a physical abrasion, or scratch, was formed to provide the deleted openings in an IRR coating having conductive and non-conductive layers on a glass substrate. A tin soldering paste filled the openings, creating a busbar for electrical connection. After lamination of the coated glass substrate, a resistance of 2.9 Ohm was determined. Where the tin filled openings were coupled with copper tape and a connector, resistance was found to be 2.7 Ohm. In a further example, an IRR coated glass substrate had physically abraded openings formed in an area to form a busbar. The openings were filled with tin paste and a copper foil was adhered to the tin using a conductive adhesive. The glass substrate was then heat treated and a connector was soldered thereto. The resistance of the heat-treated example was found to be 3.0 Ohm. The theoretical limit of the resistance in the physically abraded examples was 2.8 Ohm. Thus, each filled opening was able to form an electrical connection. The coating was not fired in the examples. Where a coating is fired, a smaller resistance may be reached. The coating deletions disclosed herein may be utilized for any electrical connection in a glazing. Further, the conductive coating having deletions may be on any suitable substrate, including glass and polymer film. For example, the conductive coating may be formed on a polyethylene terephthalate (PET) film, which may be laminated within a glazing. A polymer film coating may need to be electrically connected outside of a heat treatment, which may be accomplished by the methods described herein. Where the coating is applied to a glass substrate, the coating may be applied to any surface. Preferably, in a laminated glazing, the coating is on at least one of surfaces S2, S3, and S4.

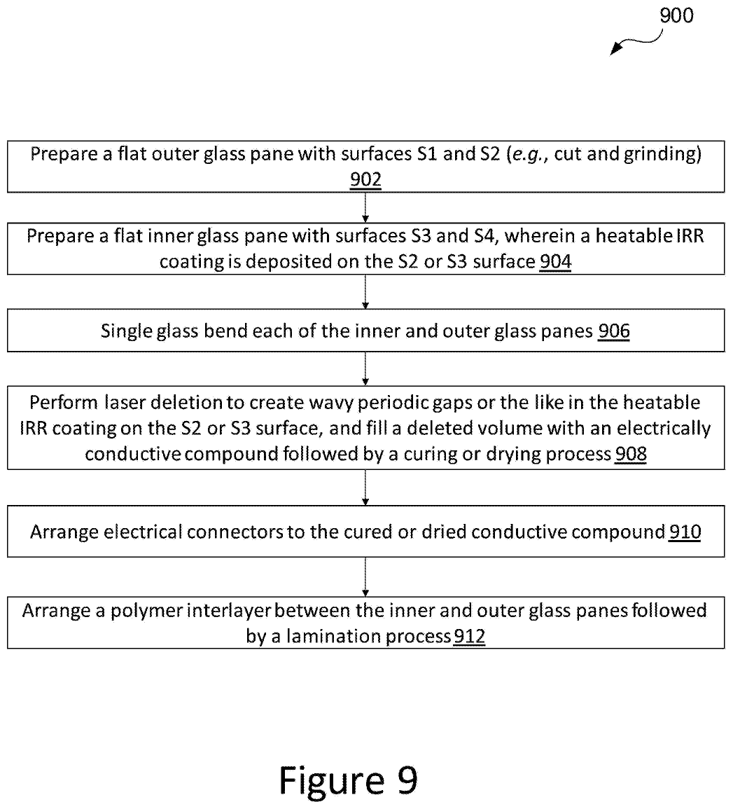

According to aspects of the present disclosure, referring to FIG. 9, a manufacturing process 900 of a conductive laminated vehicle window may comprise the following steps.

Step 902 includes preparing a flat outer glass pane with surfaces S1 and S2 (e.g., cut and grinding), with optional screen printing of opaque paste enamel (e.g., black enamel printing) on the S2 surface, and firing the optional opaque enamel.

Step 904 includes preparing a flat inner glass pane with surfaces S3 and S4, wherein a heatable IRR coating is deposited on the S2 or S3 surface, and optionally screen printing opaque or silver enamel on the S4 surface. The heatable IRR coating may be deposited by physical vapor deposition or atomic layer deposition without limitation.

Step 906 includes single glass bending of the inner and outer glass panes, respectively, by, for example, a mold press bending.

Step 908 includes laser deletion to create wavy periodic gaps (or the like) in the heatable IRR coating on the S2 or S3 surface and filling a deleted volume with an electrically conductive material followed by a curing and/or drying process for the conductive material. The cured and/or dried conductive material becomes a busbar and provides electrical contact(s) between the silver layers in the coating and an external power source (e.g., a battery in a vehicle).

Step 910 includes arranging of electrical connector(s) (such as metal plate or copper foil) to the busbar (the cured or dried conductive material). For example, an electrically conductive copper foil may be glued to the conductive material (the busbar), and then a suitable connector may be soldered on the copper foil.

Step 912 includes arranging a polymer interlayer (e.g., polyvinyl butyral, PVB, sheet of about 0.8 mm thickness) between the inner and outer glass panes, and performing a conventional lamination process (e.g., autoclaving).

In further embodiments, the laser deletion may form a linear deletion. The deletion may further be formed by physical abrasion or chemical etching. The deletion may be filled with an electrically conductive material, no matter the deletion shape. The deletion may further include separated vertical pillars within the coating.

Other conductive coatings may further be used in the disclosed methods. For example, the coating may comprise an infrared reflective coating, a nanowire coating, or a low-emissivity coating. The coating may be heatable and/or act as a source of electrical power. Any suitable glass substrate may be used in the constructions disclosed herein. In some embodiments, the glass substrate to be coated may preferably be from 0.05 mm to 2.1 mm, more preferably from 0.05 mm to 1.8 mm, and more preferably from 0.05 mm to 1.6 mm in thickness.

According to aspects of the present disclosure, a manufacturing process 1000 of a conductive laminated vehicle window may comprise the following steps.

Step 1002 includes preparing a flat outer glass pane with surfaces S1 and S2 (e.g., cut and grinding), with optional screen printing of opaque paste enamel (e.g., black enamel printing) on the S2 surface, and firing the optional opaque enamel.

Step 1004 includes preparing a flat inner glass pane with surfaces S3 and S4, and optionally screen printing opaque or silver enamel on the S4 surface.

Step 1006 includes single glass bending of the inner and outer glass panes, respectively, by, for example, mold press bending.

Step 1008 includes depositing a heatable or other functional coating onto at least one of surface S2 or surface S3. According to an aspect of the present disclosure, such a functional coating may not need to survive heat-treatment (e.g., thermal bending). That is, a functional coating not having heat-treatability (i.e., not durable in a thermal bending process) may be used during a manufacturing process with less strict requirements for physical and chemical high-durability for the heat-treatment. An example of the coating is a silver nano-wires (AgNW) heatable coating which may provide improved heating capability for defrosting, defogging or deicing.

Step 1010 includes deletion of part of the functional coating to create openings in the functional coating of step 1008 and filling a deleted volume with an electrically conductive material followed by a curing and/or drying process for the conductive material. The cured and/or dried conductive material becomes a busbar and provides electrical contacts between the silver layers in the coating and an external power source (e.g., a battery in a vehicle).

Step 1012 includes arranging of an electrical connector (such as a metal plate or copper foil) to the busbar.

Step 1014 includes arranging a polymer interlayer (e.g., polyvinyl butyral, PVB, sheet having a thickness of about 0.8 mm), and performing a conventional lamination process (e.g., autoclaving).

According to yet another aspect of the present disclosure, a manufacturing process 1100 of a conductive laminated vehicle window may comprise the following steps.

Step 1102 includes preparing a flat outer glass pane with surfaces S1 and S2 (e.g., cut and grinding), with optional screen printing of opaque paste enamel (e.g., black enamel printing) on the S2 surface, and firing the optional opaque enamel.

Step 1104 includes preparing a flat inner glass pane with surfaces S3 and S4, and optionally screen printing and firing of opaque or silver enamel on the S4 surface.

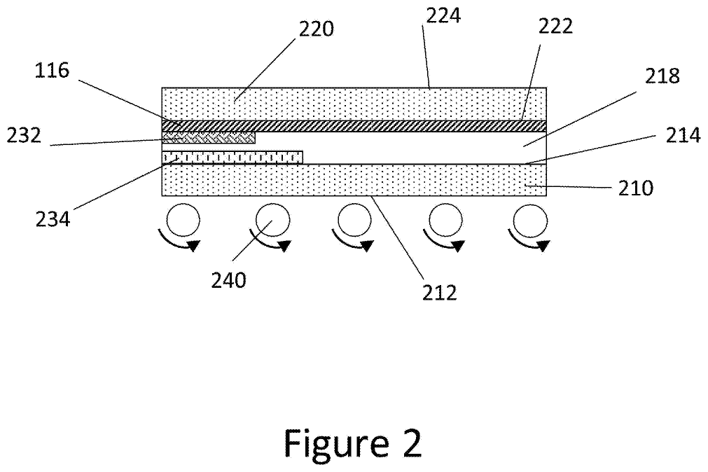

Step 1106 includes assembling the outer glass pane and inner glass pane such that the surface S1 of the outer glass pane is mostly downward (i.e., the surface S2 is upward) and the surface S3 of the inner glass pane is on and facing the surface S2 (i.e., the surface S4 is mostly upward), as shown in FIG. 2.

Step 1108 includes simultaneously bending the pair of glass panes of step 1106 (e.g., double glass bending). For example, a gravity-sag bending process may be applicable.

Step 1110 includes separating of the bent glass panes of the step 1108.

Step 1112 includes depositing of a heatable or other functional coating onto a S2 surface or S3 surface. Such a functional coating may not need to survive heat-treatment (e.g., thermal bending). That is, according to aspects of the present disclosure, a functional coating not having heat-treatability (i.e., not durable in a thermal bending process) may be used during a manufacturing process with less strict requirements for physical and chemical high-durability for the heat-treatment. An example of the coating is a silver nano-wired (SNW) heatable coating which may provide improved heating capability for defrosting, defogging or deicing.

Step 1114 includes deletion in the coating to provide an opening in the coating of step 1112 and filling a deleted volume with an electrically conductive material followed by a curing process for the conductive material. The cured conductive material becomes a busbar and provides electrical contacts between the silver layers in the coating and an external power source (e.g., a battery in a vehicle).

Step 1116 includes arranging of an electrical connector such as metal plate or copper foil to the busbar.

Step 1118 includes arranging a polymer interlayer (e.g., polyvinyl butyral, PVB, sheet having a thickness of about 0.8 mm), and performing a conventional lamination process (e.g., autoclaving).

In further embodiments, glass substrates may be coated with a conductive coating prior to double glass bending.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. For example, without limitation, the busbar creation and arrangement by the deletion disclosed in the present disclosure may be also applicable to deletion to create integrated antenna circulate (or lines) in a heatable laminated glazing (not limited to windshields) with a heatable IRR coating comprising double, triple, or more silver functional layers. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A method for producing an electrically connected coated substrate comprising:
providing a coating on at least one surface of a substrate;
creating at least one deletion in the coating to form at least one opening;
filling the at least one opening with an electrically conductive material;
curing the electrically conductive material; and
applying at least one electrical connector to the electrically conductive material.

2. The method according to claim 1, wherein the at least one opening filled with the electrically conductive material comprises at least one busbar.

3. (canceled)

4. The method according to claim 1, wherein the coating is selected from the group consisting of an infrared reflective coating, a nanowire coating, a low-emissivity coating, and a transparent conductive oxide.

5-7. (canceled)

8. The method according to claim 1, wherein the at least one opening comprises a wave structure having a frequency-type shape, wherein the frequency-type shape comprises at least one of a sinusoidal wave form, a triangle wave form or a quadrangular wave form.

9. The method according to claim 1, wherein the at least one opening is linear.

10. The method according to claim 1, wherein the at least one opening comprises a vertical pillar.

11. The method according to claim 1, wherein creating the at least one opening comprises laser etching.

12. (canceled)

13. The method according to claim 1, wherein creating the at least one opening comprises physical abrasion.

14. The method according to claim 1, wherein creating the at least one opening comprises chemical etching.

15-16. (canceled)

17. A vehicle glazing, comprising:
a first glass substrate having surfaces S1 and S2 wherein S1 faces a vehicle exterior;
a second glass substrate having surfaces S3 and S4 wherein S4 faces a vehicle interior;
at least one polymer interlayer between the first glass substrate and the second glass substrate; and
a coating on at least one surface of at least one of the first and second glass substrates, wherein at least one opening is formed in the coating, and the at least one opening is filled with an electrically conductive material, wherein the electrically conductive material is attached to at least one electrical connector.

18. The vehicle glazing according to claim 17, wherein the coating is provided on a surface selected from the group consisting of the S2 surface of the first glass substrate and the S3 surface of the second glass substrate.

19-20. (canceled)

21. The vehicle glazing according to claim 17, wherein the coating is selected from the group consisting of an infrared reflective coating, a nanowire coating, a low-emissivity coating, and a transparent conductive oxide.

22-24. (canceled)

25. The vehicle glazing according to claim 17, wherein the at least one opening comprises a wave structure having a frequency-type shape, and the frequency-type shape comprises at least one of a sinusoidal wave form, a triangle wave form or a quadrangular wave form.

26. The vehicle glazing according to claim 17, wherein the at least one opening is linear.

27. The vehicle glazing according to claim 17, wherein the at least one opening comprises a vertical pillar.

28-30. (canceled)

31. The vehicle glazing according to claim 17, wherein the at least one opening filled with the electrically conductive material comprises a busbar.

32. The method according to claim 1, wherein the at least one electrical connector includes a copper tape, and the method further comprises soldering a second connector to the copper tape.

33. The method according to claim 1, wherein a top layer of the coating is electrically non-conductive.

34. The vehicle glazing according to claim 17, wherein the at least one electrical connector includes a copper tape and a second connector attached to the copper tape.

35. The vehicle glazing according to claim 17, wherein a top layer of the coating is electrically non-conductive.
